(19) United States
(12) Patent Application Publication
(10) Pub. No.: US 2008/0166908 A1
(43) Pub. Date: Jul. 10, 2008

(54) Terminal positioning device for socket connector

(75) Inventor: Hui-Min Yu, Gueishan Township (TW)

Correspondence Address: TROXELL LAW OFFICE PLLC, 5205 LEESBURG PIKE, SUITE 1404, FALLS CHURCH, VA, 22041, US

(73) Assignee: SPEED TECH CORP., Gueishan Township (TW)

(21) Appl. No.: 11/651,609

(22) Filed: Jan. 10, 2007

(51) Int. Cl. H01R 4/26

(52) U.S. Cl. 439/346

(57) ABSTRACT

Terminals of a socket connector are directly positioned and are conducted electrically. No additional through-holes on a circuit board are required. Hence, the cost of the circuit board is reduced.

### FIELD OF THE INVENTION

The present invention relates to a terminal positioning device; more particularly, relates to positioning terminals and conducting terminals electrically by using positioning terminals and contacting terminals without additional holes on a circuit board and so cost is reduced on fabricating the circuit board.

### DESCRIPTION OF THE RELATED ART

A prior art called “Audio socket connector with a settlement board” comprising an insulated body having a receiving part in a front end; and a plurality of terminals, where the receiving part has a socket hole inside; the socket hole extends backward to inside of the insulated body to form a chamber; the insulated body has a plurality of terminal slots; and the terminals is contained in the corresponding terminal slots; the insulated body has a butting member and a cubic convex extending out at side; and the insulated body has a concave surface having a positioning convex column. Therein, the butting member butts against an outside circuit board; the cubic convex is correspondingly connected on a ladder-like convex of the circuit board; and the positioning convex column is embedded in a positioning hole of the circuit board, so that a horizontal pushing force and a pulling force are enhanced on setting the audio socket connector on the circuit board.

Although the prior art enhances a horizontal pushing force and a pulling force on setting the audio socket connector on the circuit board, the circuit board requires not only holes for soldering the terminals, but also the ladder-like convex and the positioning hole to coordinate with the cubic convex and the positioning convex column. Therefore, the circuit board is fabricated through a complex process and so the cost is increased. Hence, the prior art does not fulfill users' requests on actual use.

### SUMMARY OF THE INVENTION

The main purpose of the present invention is to position terminals and to conduct terminals electrically by using positioning terminals and contacting terminals without additional holes on a circuit board and so cost is reduced on fabricating the circuit board.

To achieve the above purpose, the present invention is a terminal positioning device for a socket connector, comprising an insulated base having socket holes at an end and slots connecting to the socket holes at two sides on a surface of the insulated base; a plurality of positioning terminals having assembling parts and positioning parts with the assembling parts set in two slots; and a plurality of contacting terminals having fixing parts and butting parts with the fixing parts set in the other slots. Accordingly, a novel terminal positioning device for a socket connect or is obtained.

### BRIEF DESCRIPTION OF THE DRAWINGS

The present invention will be better understood from the following detailed descriptions of the preferred embodiments according to the present invention, taken in conjunction with the accompanying drawings, in which

FIG. 1 is the perspective view showing the first preferred embodiment according to the present invention;

FIG. 2 is the explosive view of the first preferred embodiment;

FIG. 3 is the assembling view showing the state of use of the first preferred embodiment;

FIG. 4 is the assembled view;

FIG. 5 is the bottom-up view showing the first preferred embodiment;
FIG. 6 is the bottom-up view showing the second preferred embodiment; and

FIG. 7 is the view showing the another preferred embodiment of the positioning terminal.

### DESCRIPTIONS OF THE PREFERRED EMBODIMENTS

The following descriptions of the preferred embodiments are provided to understand the features and the structures of the present invention.

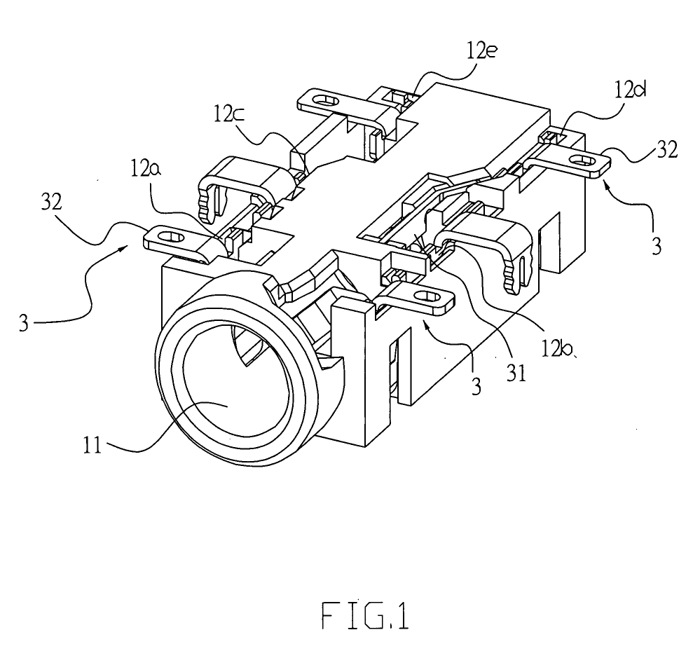

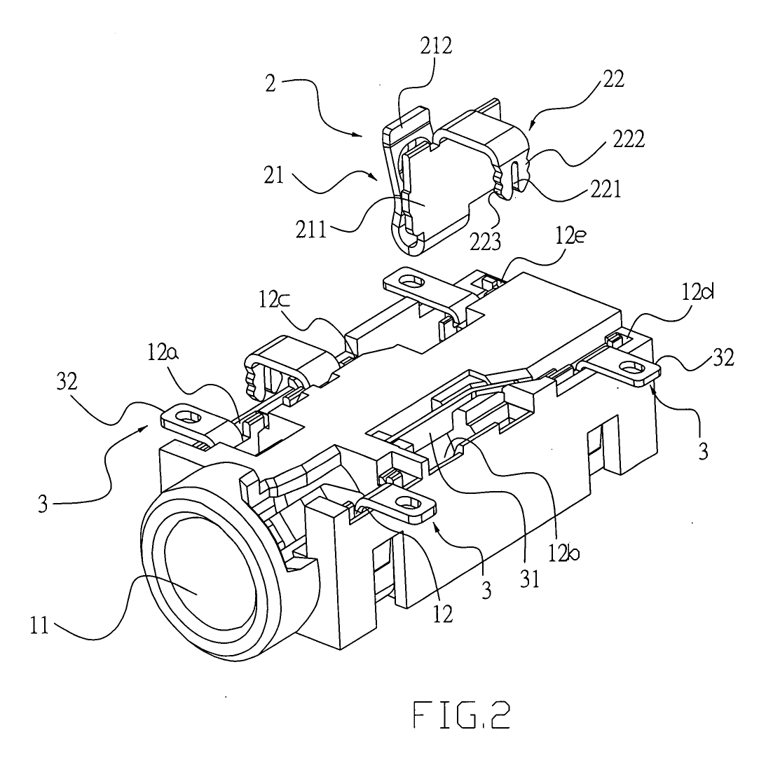

Please refer to FIG. 1 and FIG. 2, which are a perspective view and an explosive view showing a first preferred embodiment according to the present invention. As shown in the figures, the present invention is a terminal positioning device for a socket connector, comprising an insulated base 1, a plurality of positioning terminals 2 and a plurality of contacting terminals 3, where the positioning terminals 2 and the contacting terminals 3 are positioned and conducted electrically without additional holes on a circuit board and so cost is reduced on fabricating the circuit board.

The insulated base 1 has a socket hole 11 extended from an end of the insulated base 1 toward inside of the insulated base 1 for being plugged with a joint (not shown in the figures). The insulated base 1 has a plurality of slots 12, 12a, 12b, 12c, 12d, 12e at proper positions at two sides on a surface of the insulated base 1 and the slot 12, 12a˜12e is connected to the socket hole 11.

The positioning terminal 2 has an assembling part 21 at an end of the positioning terminal 2, and the assembling parts 21 are set in the slot 12b, 12c so that the assembling part 21 is correspondingly set at a side wall of the socket hole 11. The positioning terminal 2 has a bended positioning part 22 at another end. And two of the positioning terminals 2 are set in two corresponding slots 12b, 12c (or 12, 12a or 12d, 12e, for example); and are located at either end or at center of the insulated base 1. The assembling part 21 comprises a plugging plate 211 and an elastic plate 212; and the elastic plate 212 is extended from a bending at an end of the assembling part 21. The positioning part 22 has a separating notch 221 on a center line to form two elastic pins 222, where the elastic pin 222 has a sawteeth surface 223 at a side. And the sawteeth surfaces 223 of the two elastic pins 222 are oppositely faced outwardly.

The contacting terminal 3 has a fixing part 31 at an end of the contacting terminal 3 and the fixing part 31 is set in the other slot 12, 12a, 12d, 12e so that the fixing part 31 is correspondingly set at a side wall of the socket hole 11. The contacting terminal 3 has a butting part 32 at another end extending to a side of the insulated base 1. And the contacting terminal 3 is set in the other corresponding slot 12, 12a, 12d, 12e (or 12b, 12c, 12d, 12e or 12, 12a, 12b, 12c, for example). Thus, a novel terminal positioning device for a socket connector is obtained.

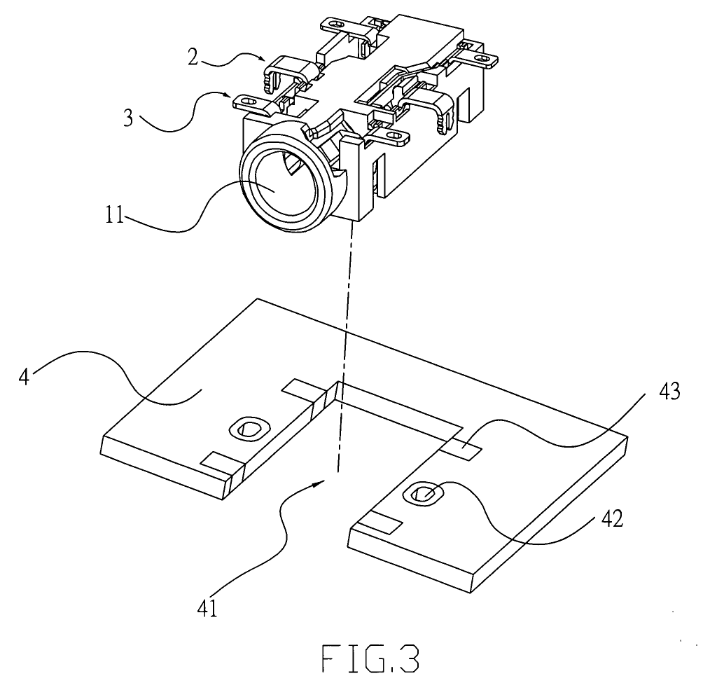

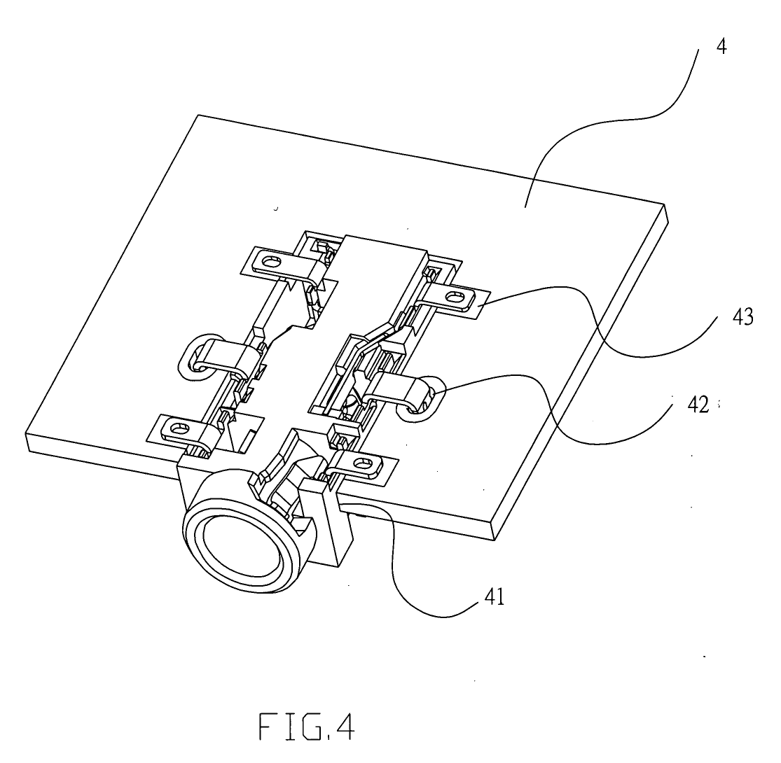

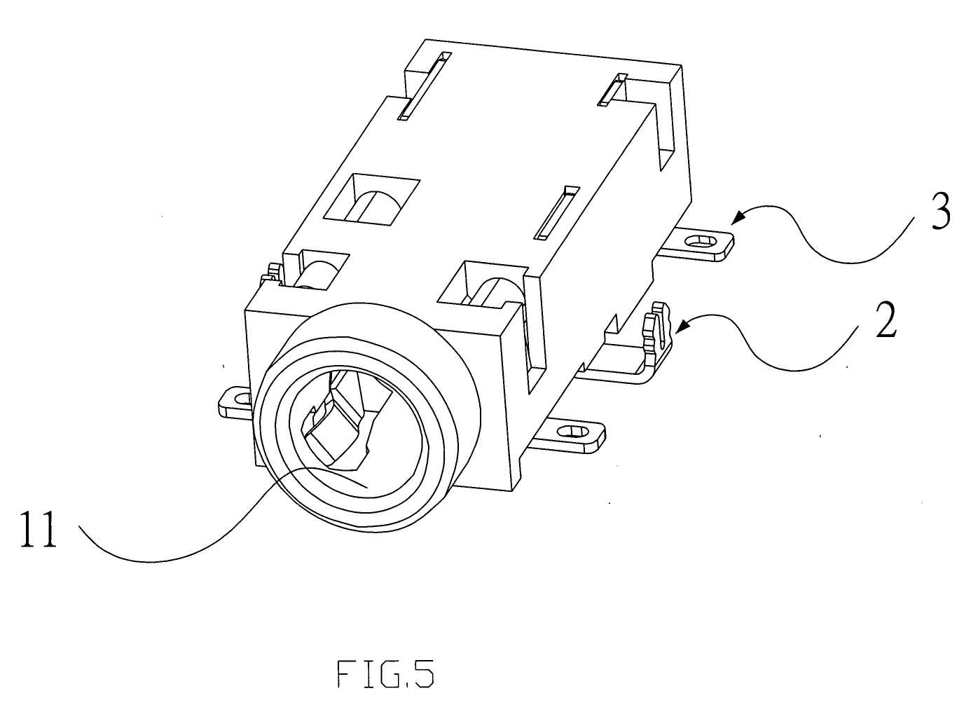

Please refer to FIG. 3 to FIG. 5, which are an assembling view and an assembled view showing a state of use of the first preferred embodiment; and a bottom-up view showing the first preferred embodiment. As shown in the figures, on using the present invention, two positioning terminals 2 are set in two slots 12b, 12c at center of the insulated base 1; and contacting terminals 3 are set in the other four slots 12, 12a, 12d, 12e at two ends of the insulated base 1.

On assembling the present invention, a circuit board 4 has an indentation 41; and the indentation 41 has two through-holes 42 and four soldering part 43 at two sides corresponding to the positioning terminals 2 and the contacting terminals 3, so that the terminal positioning device is directly corresponding to the circuit board 4 from above to be embedded in the indentation 41. The positioning parts 22 of the positioning terminals 2 at two sides of the insulated base 1 penetrate through through-holes 42. On penetrating through the through-holes 42, the pins 222 are drawn near with the separating notch 221 of the positioning part 22. After the positioning parts 22 pass through the through-holes 42, the pins 222 are restored for positioning with the interferences on the inner side obtained by sawteeth surfaces 223 of the pins 222. The butting parts 32 of the contacting terminals 3 are correspondingly butt against on the soldering part 43. Then soldering is done between positioning parts 22 and corresponding through-holes 42 and between butting parts 32 and corresponding soldering parts 43. By doing so, the positioning terminals 2 and the contacting terminals 3 are fixed on the circuit board 4 and are electrically connected.

Finally, the insulated base 1 is firmly fixed on the circuit board 4 through interferences with the separating notches 221, the pins 222, the sawteeth surfaces 223 and the through-holes 42; or with a combination of rivets, tenons and screws (not shown in the figures).

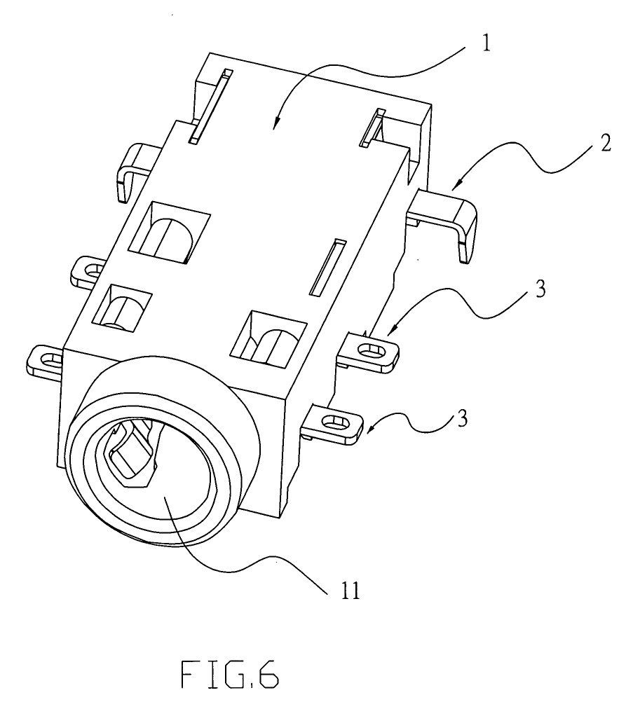

Please refer to FIG. 6, which is a bottom-up view showing a second preferred embodiment. As shown in the figure, positioning terminals 2 are set in two slots 12d, 12e at an end of an insulated base 1; and contacting terminals 3 are set in the other slots 12, 12a, 12b 12c. Thus, the positioning terminals 2 and the contacting terminals 3 change positions according to requirement.

The insulated base 1, the positioning terminals 2 and the contacting terminals 3 are correspondingly assembled upside down to the circuit board 4, as shown in FIG. 1 to FIG. 5; or, the insulated base 1, the positioning terminals 2 and the contacting terminals 3 can be correspondingly assembled bottom-up to the circuit board 4, as shown in FIG. 6. The difference is that, when the positioning terminals 2 are inserted from the top surface, as shown in FIG. 5, positioning parts 22 are bended downward to be assembled on the circuit board 4 from above; or, when the positioning terminals 2 are inserted from the bottom surface, as shown in FIG. 6, the positioning parts 22 are bended upward to be assembled on the circuit board 4 from below.

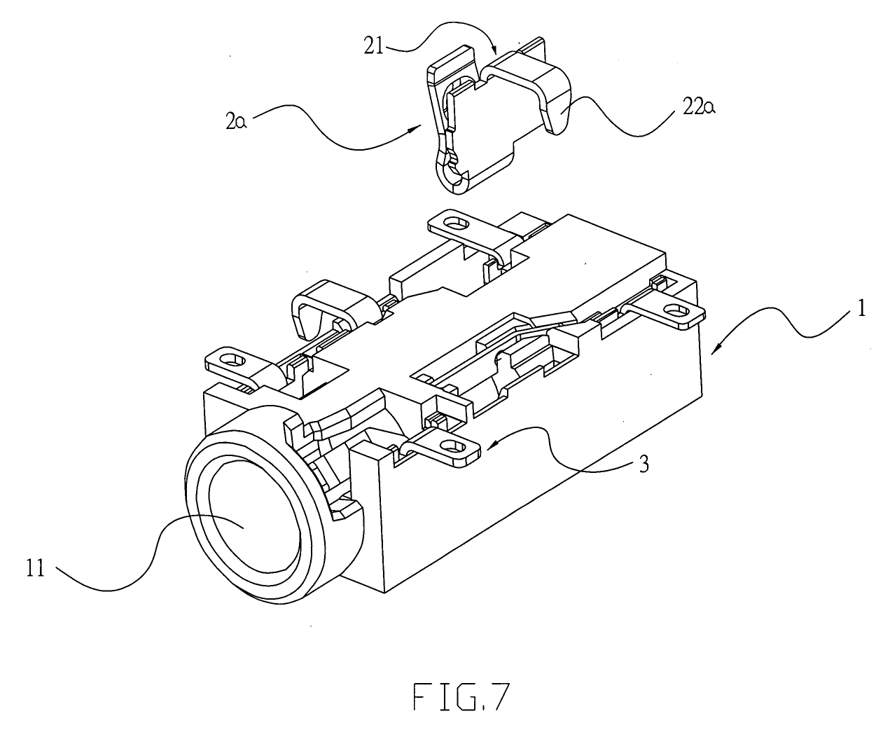

Please refer to FIG. 7, which is a view showing another preferred embodiment of a positioning terminal. As shown in the figure, a positioning terminal 2a according to the present invention has a positioning part 22a as a whole plugging plate, which achieves all the functions of the positioning terminals 2 in the previous figures.

To sum up, the present invention is a terminal positioning device for a socket connector, where positioning terminals and contacting terminals are positioned and conducted electrically without additional holes on a circuit board and so a cost is reduced on fabricating the circuit board.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A terminal positioning device for
a socket connector, comprising:
an insulated base, said insulated base having a socket hole and a plurality of slots, said socket hole being extended from a surface of said insulated base to inside of said insulated base, said slots being located at two sides on a surface of said insulated base;
a plurality of positioning terminals, said positioning terminal having an assembling part at an end of said positioning terminal, said assembling part being set in said slot, said positioning terminal having a positioning part at another end of said positioning terminal, said positioning part being bended
a plurality of contacting terminals, said contacting terminal having a fixing part at an end of said contacting terminal, said fixing part being set in said slot, said contacting terminal having a butting part at an other end of said contacting terminal, said butting part being extended to a side of said insulated base.

2. The device according to claim 1,
wherein said positioning terminals set in said slot correspondingly.

3. The device according to claim 1,
wherein said assembling part comprises a plugging plate and an elastic plate; and
wherein said elastic plate is extended from a bending at an end of said assembling part.

4. The device according to claim 1, wherein said positioning part has a separating notch on a center line to obtain two elastic pins.

5. The device according to claim 4,
wherein said pin has a sawteeth surface at a side.

6. The device according to claim 1,
wherein said positioning part is a plugging plate.

7. The device according to claim 1,
wherein said contacting terminal is set in said slot correspondingly.

8. The device according to claim 1,
wherein said positioning part is fixed to said insulated base at an end of said positioning part with a member selected from a group consisting of a rivet, a tenon and a screw.
